(19) United States
(12) Patent Application Publication
(10) Pub. No.: US 2006/0125552 A1
(43) Pub. Date: Jun. 15, 2006

(54) Voltage-multiplier circuit

(75) Inventors: Kuo Chuan Wu, Taipei (TW); Tun Jen Chen, Taipei (TW)

Correspondence Address: BUCKNAM AND ARCHER, 1077 NORTHERN BLVD., ROSLYN, NY, 11576, US

(73) Assignee: Asour Technology Inc.

(21) Appl. No.: 11/098,055

(22) Filed: Apr. 4, 2005

(30) Foreign Application Priority Data
Dec. 10, 2004 (TW) 093138377

(51) Int. Cl. G05F 1/10

(52) U.S. Cl. 327/536

(57) ABSTRACT

The invention provides a voltage-multiplier circuit, and comprises a voltage-pumping block and a functional generator. The voltage-pumping block is composed of a first diode, a second diode, a first couple capacitor, a second couple capacitor to pump an input voltage. The invention can form the multi-level voltage-pumping blocks, and the voltage-pumping block is only needed to replace the diode and the capacitor to repair and increase/decrease the numbers of the diodes and the capacitors to achieve easily adjust the range of the voltage-pumping to achieve the object of decreasing the time and costing saving.

### BACKGROUND OF THE INVENTION

1. Filed of the Invention

This invention relates to a voltage-multiplier circuit and, in particular, relates to a voltage-multiplier circuit by using diodes and capacitors to achieve the effect of the voltage-pumping.

2. Description of Prior Art

Conventionally, a step-up DC/DC controller IC using diodes, MOSFET, inductor, Schottky Diodes, and filter capacitor so as to achieve the voltage-pumping of the positive or negative voltage. As the conventional circuit of the positive voltage-multiplier circuit shown in FIG. 1, it comprises transistors or MOSFET 10, inductor 11, schottky diode 12, capacitor 13, capacitor 14, capacitor 15, and step-up DC/DC controller IC 16.

The voltage-pumping circuit having the disadvantages below: high energy of EMI caused by the result of high frequency oscillating, however, using the IC with low EMI will increase the cost of the material; the pumping-voltage IC manufactured by different company is not compatible with each other and having the effect of the product deadline and the yield; when the used IC stop manufacturing, the design and the layout of the printed circuit board must be changed.

### SUMMARY OF THE PRESENT INVENTION

Accordingly, an object of the present invention is to provide a voltage-multiplier circuit. The voltage-multiplier circuit of the present invention can fabricate a multi-level voltage-pumping blocks, and the voltage-pumping blocks just need to replace diodes and capacitors so that proceed fixing and adjusting the range of the voltage-pumping without using voltage-pumping chip, changing the layout of the printed circuit board or the design of the circuit. Therefore, the present invention is further to achieve the purpose of the cost down and easy for fixing.

To achieve the object of the present invention above, the present invention is to provide a voltage-multiplier circuit, comprising a first voltage-pumping block. The first voltage-pumping block includes a first diode, a second diode, a first coupling capacitor and a second coupling capacitor. A functional generator circuit for generating a functional signal; wherein a side of the first diode for receiving an input voltage, and the other side of the first diode being connected to a side of the first coupling capacitor and the second diode, the other side of the first coupling capacitor receiving the functional signal, the other side of the second diode being connected to a side of the second coupling capacitor so as to output an output voltage, the other side of the second coupling capacitor being connected to a ground.

The present invention is to provide another voltage-multiplier circuit, comprising a plurality of voltage-pumping blocks for pumping a voltage; and a functional generator for generating a functional signal; wherein each of the voltage-pumping blocks including a first diode, a second diode, a first coupling capacitor and a second coupling capacitor; a side of the first diode for receiving an input voltage and the other side being connected to a side of the first coupling capacitor and the second diode, the other side of the first coupling capacitor receiving the functional signal, the other side of the second diode being connected to a side of the second coupling capacitor so as to output a output voltage, the other side of the second coupling capacitor being connected to a ground; prior level of the voltage-pumping blocks being served as next level of the input voltage of voltage-pumping blocks; the other side of the second diode of prior level of the voltage-pumping blocks being connected to the side of the first diode of next level of the voltage-pumping blocks.

As mentioned above, the present invention can achieve the advantages below:
1. Low cost and the functional signal, which is a sine wave, a square wave, triangular wave, pulse wave or an irregular wave, and its circuit can be a transistor, OP amp, standard logic IC or a crystal oscillator;
2. low frequency and low EMI;
3. frequency of oscillator is fixed, radiation of electromagnetic is easy to be suppressed;
4. the circuit is simple and easy to maintain. Thus, it is easy to reduce the cost of product indirectly and the cost of fix;
5. it is easy to obtain the material, and to short the deadline of manufacturing the product. The material has high characteristic of replacement without requirement of specific specification;
6. at the environment of the single power, using the necessary functional generator and adding the circuit consists of the diodes and the capacitors of the present invention to generate the positive voltage to offer the requirement by the grid of the VFD without using the conventional circuit which is expensive and complicated;
7. it depends on the requirement of the voltage to increase or decrease the numbers of the circuit consists of the diodes and the capacitors or adding the device for stabilizing the voltage (such as zener diode or regulator IC) at the output of the pumping voltage so that to generate the required voltage.

### BRIEF DESCRIPTION OF THE DRAWINGS

FIG. 1 is a diagram showing positive voltage-pumping circuit according to a conventional technique;

FIG. 2a is a diagram of the positive voltage-multiplier according to the preferred embodiment of the present invention;

FIG. 2b is a circuit diagram of the positive voltage-multiplier according to the preferred embodiment of the present invention;

FIG. 2c is a diagram of the negative voltage-multiplier according to the preferred embodiment of the present invention.

FIG. 2d is a circuit according to the negative voltage-multiplier circuit in FIG. 2c;

FIG. 3a is a circuit diagram of the positive voltage-multiplier according to another preferred embodiment of the present invention;

FIG. 3b is a circuit diagram of the negative voltage-multiplier according to another preferred embodiment of the present invention;

FIG. 3c is a circuit diagram of applying the positive and the negative voltage-multiplier at the same time according to another preferred embodiment of the present invention;

FIG. 4 is a circuit diagram of applying voltage-multiplier at the VFD according to another preferred embodiment of the present invention.

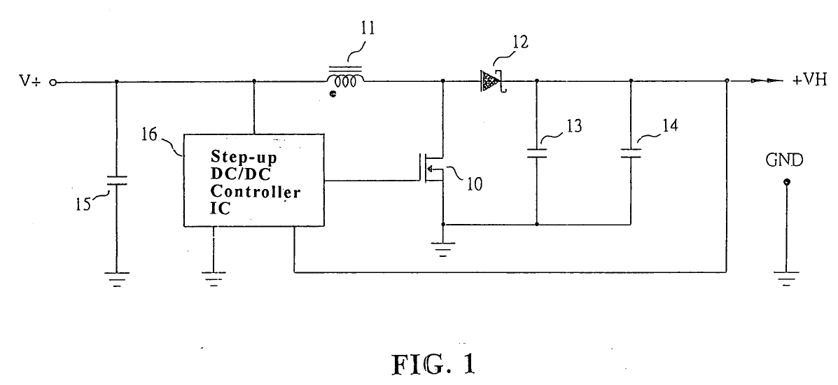

### DETAILED DESCRIPTION OF THE PREFFERED EMBODIMENT

Now, the preferred embodiments according to the present invention will be described with references to the accompanying drawings.

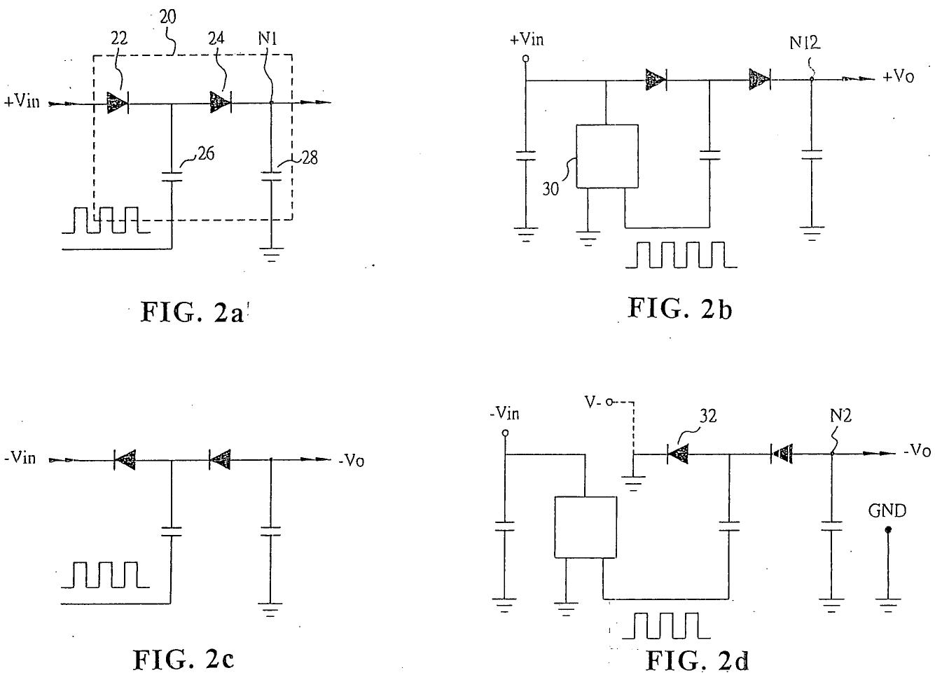

FIG. 2a is a diagram of the positive voltage-multiplier according to the preferred embodiment of the present invention. Referring to the FIG. 2a, the positive voltage-multiplier circuit includes a voltage-pumping block 20. The voltage-pumping block 20 comprises a first diode 22, a second diode 24, a first coupling capacitor 26 and a second coupling capacitor 28, wherein a side of the first diode 22 for receiving a positive voltage Vin, and the other side of the first diode 22 is connected to a side of the first coupling capacitor 26 and the second diode 24. The other side of the first coupling capacitor 26 receives a functional signal. The other side of the second diode 24 is connected to a side of the second coupling capacitor 28 and output a voltage at node N1. The other side of second coupling capacitor 28 is connected to ground.

FIG. 2b is a circuit diagram of the positive voltage-multiplier according to the preferred embodiment of the present invention. Referring to FIG. 2b, wherein comprising a functional generator circuit 30 for generating a functional signal; wherein the functional signal is a sine wave, a square wave, triangular wave, pulse wave or an irregular wave. As shown at node N12, the output voltage Vo as shown below:
Vo=Viₚₑₐₖ+Vin.

FIG. 2c is a diagram of the negative voltage-multiplier according to the preferred embodiment of the present invention. Referring to FIG. 2c and FIG. 2a, in this embodiment, the diode is connected reversely, and there is provided a negative voltage instead of the positive voltage in the FIG. 2a so that it can complete a simple negative voltage-multiplier circuit.

FIG. 2d is a circuit according to the negative voltage-multiplier circuit in FIG. 2c. There is outputting a voltage value: −Vo=Viₚₑₐₖ+(|−Vin|). It outputs at node N2. When the input voltage is V−, one side of the diode is receiving a negative voltage or connected to ground.

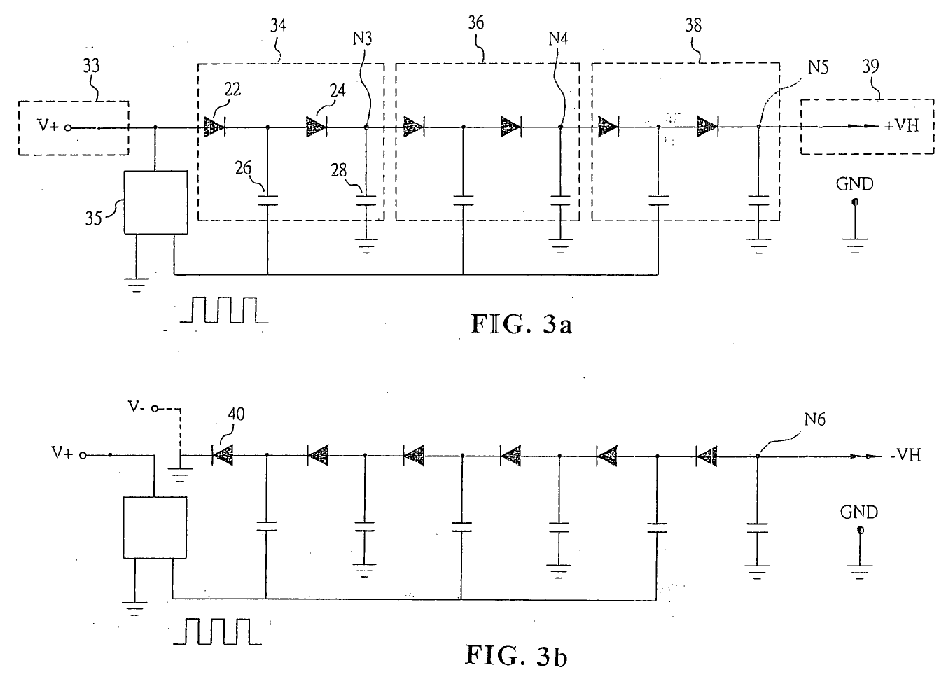

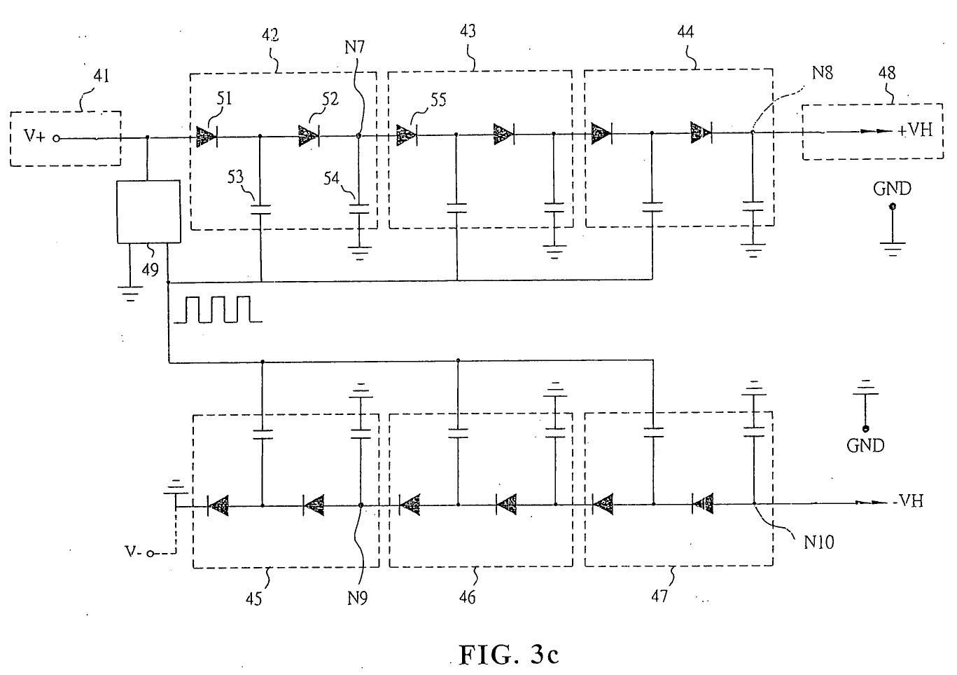

FIG. 3a is a circuit diagram of the positive voltage-multiplier according to another preferred embodiment of the present invention. Referring to FIG. 3a, the voltage-multiplier circuit comprises: a input circuit 33 for receiving a input voltage V+; a plurality of voltage-pumping blocks such as a first positive voltage-pumping block 34, a second positive voltage-pumping block all for pumping a voltage; a node N5 for outputting a output voltage; a functional generator 35 for generating a functional signal; each of the voltage-pumping blocks includes a first diode 22, a second diode 24, a first coupling capacitor 26 and a second coupling capacitor 28; a side of the first diode 22 for receiving an input voltage V+ and the other side being connected to a side of the first coupling capacitor 26 and the second diode 24, the other side of the first coupling capacitor 26 receiving the functional signal, the other side of the second diode 24 being connected to a side of the second coupling capacitor 28 so as to output a output voltage, the other side of the second coupling capacitor 28 being connected to a ground.

As mentioned above, each of the prior level of the voltage-pumping blocks being served as next level of the input voltage of voltage-pumping blocks; the other side of the second diode of prior level of the voltage-pumping blocks being connected to the side of the first diode of next level of the voltage-pumping blocks, a side of the first diode for receiving an input voltage, and the other side of the first diode being connected to a side of the first coupling capacitor and the second diode, the other side of the first coupling capacitor receiving the functional signal, the other side of the second diode being connected to a side of the second coupling capacitor so as to output an output voltage, the other side of the second coupling capacitor being connected to a ground.

FIG. 3b is a circuit diagram of the negative voltage-multiplier according to another preferred embodiment of the present invention. This embodiment applies the three negative voltage-pumping block to pumping the negative voltage, and output an voltage value: −Vo=3×Viₚₑₐₖ+(|V−|).

At the other embodiment of the present invention, it is not limited to just use the three positive voltage-pumping blocks or three negative voltage-pumping blocks, on the contrary, we can use the positive voltage-pumping blocks and the negative voltage-pumping blocks at the same time, and properly adjust the numbers of the voltage-pumping blocks according to the voltage of the load.

FIG. 3c is a circuit diagram of applying the positive and the negative voltage-multiplier at the same time according to another preferred embodiment of the present invention. FIG. 3c shows the present invention can proceed the voltage-pumping of the positive and negative voltage. The voltage-multiplier of this embodiment comprises an input circuit 41 for receiving an input voltage; a plurality of the positive voltage-pumping blocks for pumping the voltage; a plurality of the negative voltage-pumping blocks for pumping the voltage; a node N8 for outputting the positive voltage; a node N10 for outputting the negative voltage; a functional generator 49 for generating a functional signal; each of the voltage-pumping blocks including a first diode 51, a second diode 52, a first coupling capacitor 53 and a second coupling capacitor 54; a side of the first diode 51 for receiving an input voltage and the other side being connected to a side of the first coupling capacitor 53 and the second diode 52, the other side of the first coupling capacitor 53 receiving the functional signal, the other side of the second diode 52 being connected to a side of the second coupling capacitor 54 so as to output a output voltage, the other side of the second coupling capacitor 54 being connected to a ground; wherein prior level of the voltage-pumping blocks being used as next level of the input voltage of voltage-pumping blocks; the other side of the second diode 52 of prior level of the voltage-pumping blocks being connected to the side of the first diode 55 of next level of the voltage-pumping blocks.

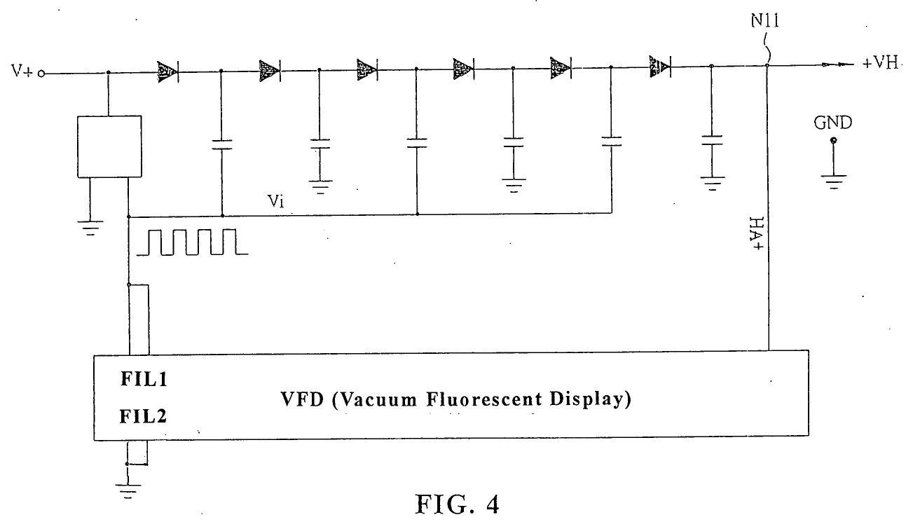

FIG. 4 is a circuit diagram of applying voltage-multiplier at the VFD according to another preferred embodiment of the present invention. In this embodiment, the positive voltage-pumping block is applied to the VFD, and it is easy to pumping the input voltage to the required voltage by using this easy voltage-multiplier circuit without using the IC with high price. There is just using the circuit consists of the diodes and the capacitors to generate the positive high voltage to offer the grid of the VFD instead of using the conventional circuit with high price. Besides, the proposed circuit of the present invention is easy to obtain the material, to short the deadline of manufacturing the product, to replace the material easily, and there is no special requirement of spec.

In an another embodiment, we can adding the device for stabilizing voltage (such as zener diode or regulator IC), wherein the functional signal is a sine wave, a square wave, triangular wave, pulse wave or an irregular wave, the output voltage can apply to the VFD.

Although the foregoing description has been made with reference to the preferred embodiments, it is to be understand that changes and modifications of the present invention may be by the ordinary skilled in the art without departing from the spirit and scope of the present invention and appended claims.

What is claimed is:

1. A voltage-multiplier circuit comprising:
a voltage-pumping block including a first diode, a second diode, a first coupling capacitor and a second coupling capacitor; and
a functional generator circuit for generating a functional signal;
wherein a side of the first diode for receiving an input voltage, and the other side of the first diode being connected to a side of the first coupling capacitor and the second diode, the other side of the first coupling capacitor receiving the functional signal, the other side of the second diode being connected to a side of the second coupling capacitor so as to output an output voltage, the other side of the second coupling capacitor being connected to a ground.

2. The voltage-multiplier circuit according to claim 1, wherein the input voltage is positive or negative.

3. The voltage-multiplier circuit according to claim 1, wherein the function signal is a sine wave, a square wave, triangular wave, pulse wave or an irregular wave.

4. The voltage-multiplier circuit according to claim 1, wherein the output voltage is outputted to a vacuum fluorescent display.

5. A voltage-multiplier circuit comprising:
a plurality of voltage-pumping blocks for pumping a voltage; and
a functional generator for generating a functional signal;
wherein each of the voltage-pumping blocks including a first diode, a second diode, a first coupling capacitor and a second coupling capacitor; a side of the first diode for receiving an input voltage and the other side being connected to a side of the first coupling capacitor and the second diode, the other side of the first coupling capacitor receiving the functional signal, the other side of the second diode being connected to a side of the second coupling capacitor so as to output a output voltage, the other side of the second coupling capacitor being connected to a ground;
wherein the prior level of the voltage-pumping blocks being served as the next level of the input voltage of voltage-pumping blocks; the other side of the second diode of the prior level of the voltage-pumping blocks being connected to the side of the first diode of next level of the voltage-pumping blocks.

6. The voltage-multiplier circuit according to claim 5, wherein the input voltage is positive or negative.

7. The voltage-multiplier circuit according to claim 5, wherein the functional signal is a sine wave, a square wave, triangular wave, pulse wave or an irregular wave.

8. The voltage-multiplier circuit according to claim 5, wherein the output voltage is outputted to a vacuum fluorescent display.

9. A voltage-multiplier circuit comprising:
a plurality of a positive voltage-pumping blocks for pumping a voltage;
a plurality of a negative voltage-pumping block for pumping another voltage; and
a functional generator for generating a functional signal;
wherein each of the positive or negative voltage-pumping blocks including a first diode, a second diode, a first coupling capacitor and a second coupling capacitor; a side of the first diode for receiving an input voltage and the other side being connected to a side of the first coupling capacitor and the second diode, the other side of the first coupling capacitor receiving the functional signal, the other side of the second diode being connected to a side of the second coupling capacitor so as to output a output voltage, the other side of the second coupling capacitor being connected to a ground;
wherein the prior level of the voltage-pumping blocks being used as the next level of the input voltage of voltage-pumping blocks; the other side of the second diode of prior level of the voltage-pumping blocks being connected to the side of the first diode of next level of the voltage-pumping blocks.

10. The voltage-multiplier circuit according to claim 9, wherein the input voltage is positive or negative.

11. The voltage-multiplier circuit according to claim 9, wherein the functional signal is a sine wave, a square wave, triangular wave, pulse wave or an irregular wave.

12. The voltage-multiplier circuit according to claim 9, wherein the output voltage is outputted to a vacuum fluorescent display.
